(19) United States
(12) Patent Application Publication
(10) Pub. No.: US 2014/0212799 A1
(43) Pub. Date: Jul. 31, 2014

(54) ELECTROPHOTOGRAPHIC PHOTORECEPTOR, PROCESS CARTRIDGE, AND IMAGE FORMING APPARATUS

(71) Applicant: FUJI XEROX CO., LTD., Tokyo (JP)

(72) Inventors: Jiro KORENAGA, Kanagawa (JP); Hirofumi NAKAMURA, Kanagawa (JP); Mitsuhide NAKAMURA, Kanagawa (JP)

(73) Assignee: FUJI XEROX CO., LTD., Tokyo (JP)

(21) Appl. No.: 14/026,252

(22) Filed: Sep. 13, 2013

(30) Foreign Application Priority Data
Jan. 28, 2013 (JP) 2013-013267

(51) Int. Cl. G03G 15/00; G03G 21/18

(52) U.S. Cl. CPC G03G 5/047; G03G 21/1814
USPC 430/56; 399/111; 430/58.05; 430/58.25; 399/159

(57) ABSTRACT

An electrophotographic photoreceptor includes a conductive substrate; an undercoat layer that is provided on the conductive layer and includes a binder resin, metal oxide particles, and an electron-accepting compound having an acidic group; and a photosensitive layer that is provided on the undercoat layer, wherein when the undercoat layer has a thickness of 20 μm, a transmittance T1 of the undercoat layer to light having a wavelength of 1000 nm, a transmittance T2 of the undercoat layer to light having a wavelength of 650 nm, and a transmittance T3 of the undercoat layer to light having a maximum absorption peak wavelength of the electron-accepting compound in a wavelength range from 300 nm to 1000 nm satisfy the following expressions (1) and (2):

5≦T1/T2≦40 Expression (1):

0.25≦−log₁₀(T3) Expression (2):.

### CROSS-REFERENCE TO RELATED APPLICATIONS

This application is based on and claims priority under 35 USC 119 from Japanese Patent Application No. 2013-013267 filed Jan. 28, 2013.

### BACKGROUND

1. Technical Field

The present invention relates to an electrophotographic photoreceptor, a process cartridge, and an image forming apparatus.

2. Related Art

An electrophotographic image forming apparatus has been used for image forming apparatuses in copying machines, laser beam printers, and the like due to its high speed and high printing quality. Photoreceptors used for the image forming apparatuses have mainly been organic photoreceptors using an organic photoconductive material. When an organic photoreceptor is prepared, there are many cases in which an undercoat layer (also called an intermediate layer) is formed on, for example, an aluminum substrate; and a photosensitive layer, in particular, a photosensitive layer including a charge generation layer and a charge transport layer is formed on the undercoat layer.

### SUMMARY

According to an aspect of the invention, there is provided an electrophotographic photoreceptor including: a conductive substrate; an undercoat layer that is provided on the conductive layer and includes a binder resin, metal oxide particles, and an electron-accepting compound having an acidic group; and a photosensitive layer that is provided on the undercoat layer, wherein when the undercoat layer has a thickness of 20 μm, a transmittance T1 of the undercoat layer to light having a wavelength of 1000 nm, a transmittance T2 of the undercoat layer to light having a wavelength of 650 nm, and a transmittance T3 of the undercoat layer to light having a maximum absorption peak wavelength of the electron-accepting compound in a wavelength range from 300 nm to 1000 nm satisfy the following expressions (1) and (2):

5≦T1/T2≦40 Expression (1):

0.25≦−log₁₀(T3) Expression (2):.

### BRIEF DESCRIPTION OF THE DRAWINGS

Exemplary embodiments of the present invention will be described in detail based on the following figures, wherein:

FIG. 1 is a diagram schematically illustrating an example of a layer configuration of an electrophotographic photoreceptor according to an exemplary embodiment of the invention;

FIG. 2 is a diagram schematically illustrating another example of the layer configuration of the electrophotographic photoreceptor according to the exemplary embodiment;

FIG. 3 is a diagram schematically illustrating another example of the layer configuration of the electrophotographic photoreceptor according to the exemplary embodiment;

FIG. 4 is a diagram schematically illustrating another example of the layer configuration of the electrophotographic photoreceptor according to the exemplary embodiment;

FIG. 5 is a diagram schematically illustrating another example of the layer configuration of the electrophotographic photoreceptor according to the exemplary embodiment;

FIG. 6 is a diagram schematically illustrating another example of the layer configuration of the electrophotographic photoreceptor according to the exemplary embodiment; and

FIG. 7 is a diagram schematically illustrating a configuration of an image forming apparatus according to the exemplary embodiment.

### DETAILED DESCRIPTION

Hereinafter, an exemplary embodiment which is an example of the invention will be described.

### Electrophotographic Photoreceptor

An electrophotographic photoreceptor according to the exemplary embodiment (hereinafter, also referred to as “the photoreceptor”) includes a conductive substrate, an undercoat layer that is provided on the conductive substrate, and a photosensitive layer that is provided on the undercoat layer.

The undercoat layer includes a binder resin, metal oxide particles, and an electron-accepting compound having an acidic group.

When the undercoat layer has a thickness of 20 μm, a transmittance T1 of the undercoat layer to light having a wavelength of 1000 nm, a transmittance T2 of the undercoat layer to light having a wavelength of 650 nm, and a transmittance T3 of the undercoat layer to light having a maximum absorption peak wavelength of the electron-accepting compound in a wavelength range from 300 nm to 1000 nm satisfy the following expressions (1) and (2).

5≦T1/T2≦40 Expression (1):

0.25≦−log₁₀(T3) Expression (2):

In recent years, the requirements for image quality, in particular, have become strict with regard to, for example, photoreceptors for the printing market. In order to meet the requirements, a technique is known in which a binder resin, metal oxide particles, and an electron-accepting compound are incorporated into an undercoat layer of an electrophotographic photoreceptor to control the resistance of the undercoat layer, thereby stabilizing the electrical characteristics of a photoreceptor and improving image quality stability.

However, a residual potential may increase even with the composition of the undercoat layer into which a binder resin, metal oxide particles, and an electron-accepting compound are incorporated.

In electrophotographic image forming processes, regarding the movement of charge in the undercoat layer particularly during negative charging, it is considered that carriers (electrons) generated in a photosensitive layer (for example, a charge generation layer) are injected into the undercoat layer during exposure. In the undercoat layer, these injected carriers move through the insides of the metal oxide particles, the surfaces of the metal oxide particles, and the electron-accepting compound while causing hopping conduction to occur therebetween. At this time, it is considered that the movement (conduction) of the carriers is largely affected by a dispersion state of the metal oxide particles in the undercoat layer and the amount of the electron-accepting compound incorporated.

Therefore, it is considered that, depending on the dispersion state of the metal oxide particles in the undercoat layer and the amount of the electron-accepting compound incorporated, the carriers in the undercoat layer are difficult to move (conduct) and thus accumulate; an internal electric field in the photosensitive layer significantly deteriorates; holes, for example, becomes a residual electric charge; and as a result, a residual potential increases.

On the other hand, when the undercoat layer including a binder resin, metal oxide particles, and an electron-accepting compound having an acidic group satisfies the expressions (1) and (2), an increase in residual potential is suppressed.

The reason is not clear but is considered to be as follows.

First, it is considered that, when the dispersion state of the metal oxide particles is low, for example, the metal oxide particles form aggregates and are dispersed (the particle diameter is great); and thus, light scattering is severe in the undercoat layer and a transmittance is low.

It is considered that, as the dispersion state of the metal oxide particles is improved, aggregates of the metal oxide particles are reduced (the particle diameter is reduced); the light scattering in the undercoat layer is weakened; and a transmittance to light having a wavelength in the near infrared range starts to increase. Moreover, it is considered that, when the dispersion state is further improved, a transmittance to light in the visible light range having a shorter wavelength gradually increases.

That is, “T1/T2” in the expression (1) refers to the ratio of the transmittance T1 of the undercoat layer (the undercoat layer having a thickness of 20 μm) to light having a long wavelength of 1000 nm to the transmittance T2 of the undercoat layer (the undercoat layer having a thickness of 20 μm) to light having a shorter wavelength of 650 nm; and represents the degree to which the dispersion state of the metal oxide particles is improved. In this case, T1 indicates the state in which the dispersion state of the metal oxide particles is improved to some degree; and T2 indicates to which degree the dispersion state of the metal oxide particles is improved.

“T1/T2” in the expression (1) being in the above-described range represents the metal oxide particles being included in the undercoat layer in an appropriate dispersion state from the viewpoint of suppressing an increase in residual potential. Specifically, for example, the metal oxide particles are included in the undercoat layer in a state where the distances between the metal oxide particles are uniform and are maintained as appropriate.

On the other hand, “−log₁₀(T3)” in the expression (2) refers to the negative value of common logarithm of the transmittance T3 of the undercoat layer to light having a maximum absorption peak wavelength of the electron-accepting compound in a wavelength range from 300 nm to 1000 nm. That is, “−log₁₀(T3)” refers to the absorbance of the electron-accepting compound. Therefore, “−log₁₀(T3)” in the expression (2) indicates to which degree the electron-accepting compound is incorporated into the undercoat layer.

“−log₁₀(T3)” in the expression (2) being in the above-described range represents the electron-accepting compound being sufficiently included in the undercoat layer from the viewpoint of suppressing an increase in residual potential.

Therefore, it is considered that, when the undercoat layer satisfies the expressions (1) and (2), in the undercoat layer, carriers injected into the undercoat layer move through the inside of the metal oxide particles, the surfaces of the metal oxide particles, and the electron-accepting compound while causing hopping conduction therebetween; and the accumulation of the carriers in the undercoat layer is suppressed.

For the above-described reasons, an increase in residual potential is suppressed in the electrophotographic photoreceptor according to the exemplary embodiment.

In addition, since an increase in residual potential is suppressed in the photoreceptor according to the exemplary embodiment, cycle characteristics in photoreceptor potential are improved (changes in photoreceptor potential due to repetitive use are suppressed) and, for example, the lifetime of the electrophotographic photoreceptor is more likely to be increased.

In an image forming apparatus (process cartridge) including the electrophotographic photoreceptor according to the exemplary embodiment, an image is obtained in which image defects (for example, ghosting (change in density caused by the history of a previous cycle)) caused by an increase in residual potential are suppressed.

In addition, particularly in an image forming apparatus (process cartridge) including a contact charging type charging unit, it is considered that local discharge is likely to occur; and, when the in-plane nonuniformity of the undercoat layer is great, abnormal discharge is more likely to occur.

Therefore, in the image forming apparatus (process cartridge) including a contact charging type charging unit, fogging (phenomenon in which toner is attached onto a non-image portion) is likely to occur. However, when the electrophotographic photoreceptor according to the exemplary embodiment is applied, it is considered that the undercoat layer satisfies the expressions (1) and (2) and has an appropriate impedance (resistance); and thus, the leakage resistance of the undercoat layer is improved. As a result, an image in which fogging is suppressed is obtained.

Hereinafter the electrophotographic photoreceptor according to the exemplary embodiment will be described with reference to the drawings.

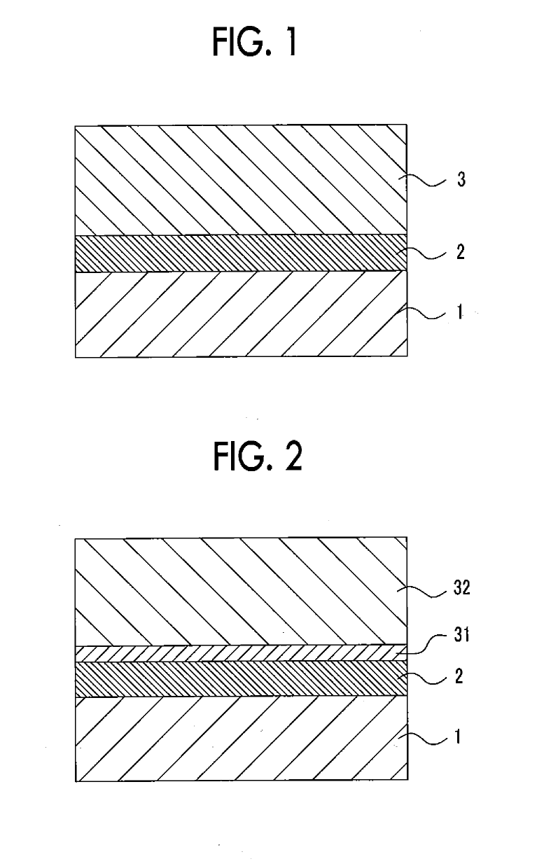

FIGS. 1 to 6 are diagrams schematically illustrating examples of a layer configuration of the photoreceptor according to the exemplary embodiment. A photoreceptor shown in FIG. 1 includes a conductive substrate 1, an undercoat layer that is formed on the conductive substrate 1, and a photosensitive layer 3 that is formed on the undercoat layer 2.

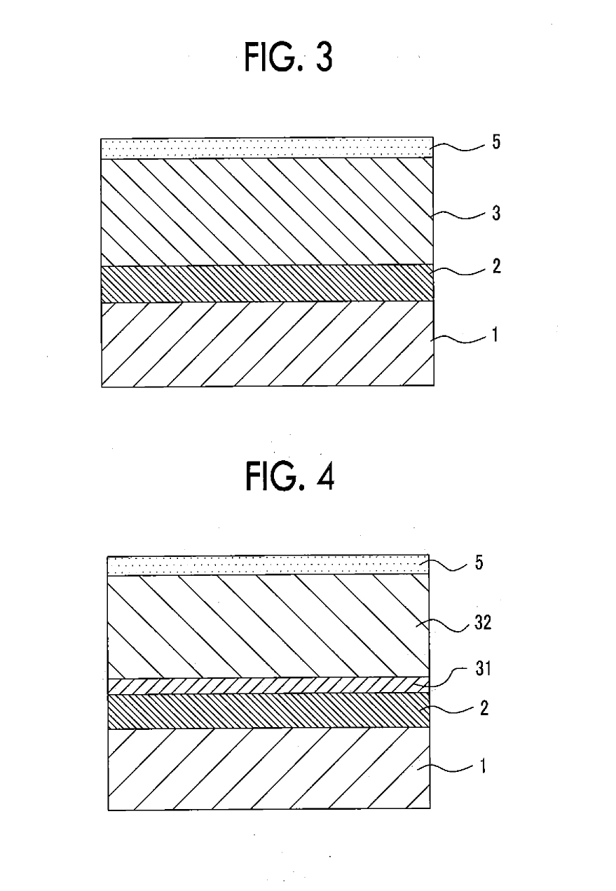

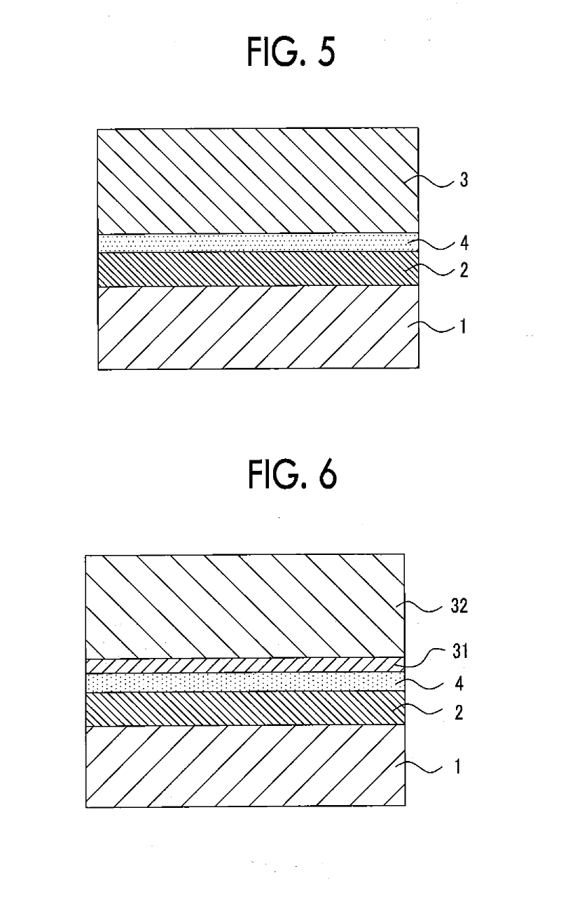

In addition, as illustrated in FIG. 2, the photosensitive layer 3 may have a two-layer structure including a charge generation layer 31 and a charge transport layer 32. Furthermore, as illustrated in FIGS. 3 and 4, a protective layer 5 may be provided above the photosensitive layer 3 or above the charge transport layer 32. In addition, as illustrated in FIGS. 5 and 6, an intermediate layer 4 may be provided between the undercoat layer 2 and the photosensitive layer 3 or between the undercoat layer 2 and the charge generation layer 31.

In the drawings, the intermediate layer 4 is provided between the undercoat layer 2 and the photosensitive layer 3 or between the undercoat layer 2 and the charge generation layer 31. However, the intermediate layer may be provided between the conductive substrate 1 and the undercoat layer 2. Of course, the intermediate layer 4 is not necessarily provided.

Next, the respective elements of the electrophotographic photoreceptor will be described. In the following description, reference numerals will be omitted.

### Conductive Substrate

As the conductive substrate, any substrates which are well-known in the related art may be used. Examples thereof include a resin film in which a thin film (for example, a metal such as aluminum, nickel, chromium, or stainless steel and a film of aluminum, titanium, nickel, chromium, stainless steel, gold, vanadium, tin oxide, indium oxide, indium tin oxide (ITO), or the like) is provided; a paper to which a conductivity-imparting agent is applied or is immersed therein; and a resin film to which a conductivity-imparting agent is applied or is immersed therein. The shape of the substrate is not limited to a cylindrical shape and may be a sheet-shape or a plate-shape.

When a metal pipe is used as the conductive substrate, the surface of the pipe may be used as it is or may be treated in advance in various processes of mirror-cutting, etching, anodic oxidation, roughing, centerless grinding, sandblasting, wet honing, and the like.

### Undercoat Layer

### Transmittance

The undercoat layer satisfies the expression (1). However, it is preferable that the undercoat layer satisfy the following expression (1-1), and it is more preferable that the undercoat layer satisfy the following expression (1-2), from the viewpoint of suppressing an increase in residual potential.

5≦T1/T2≦40 Expression (1):

8≦T1/T2≦38 Expression (1-1):

10≦T1/T2≦35 Expression (1-2):

When “T1/T2” in the expression (1) is less than 5, the dispersion state of the metal oxide particles is low, the resistance (impedance) of the undercoat layer is reduced, and the leakage resistance is difficult to secure. As a result, fogging is likely to occur. When “T1/T2” is greater than 40, the dispersion state of the metal oxide particles is excessively high, the resistance (impedance) of the undercoat layer is excessively increased, and charge is likely to accumulate in the undercoat layer. As a result, a residual potential is increased.

“T1/T2” in the expression (1) is made to be in the above-described range by controlling, for example, 1) the kind, addition amount, and particle diameter of the metal oxide particles; 2) the kind and treatment amount of a surface treatment agent for the metal oxide particles; 3) dispersion conditions (dispersion time and dispersion temperature) of the metal oxide particles in a coating solution; and 4) drying conditions (drying time and drying temperature) of the undercoat layer.

The undercoat layer satisfies the expression (2). However, it is preferable that the undercoat layer satisfy the following expression (2-1), and it is more preferable that the undercoat layer satisfy the following expression (2-2), from the viewpoint of suppressing an increase in residual potential.

0.25≦−log₁₀(T3) Expression (2):

0.3≦−log₁₀(T3)≦3 Expression (2-1):

0.35≦−log₁₀(T3)≦2.7 Expression (2-2):

When “−log₁₀(T3)” in the expression (2) is less than 0.25, the amount of the electron-accepting compound incorporated is excessively reduced; and charge is likely to accumulate in the undercoat layer. As a result, a residual potential is increased.

When “−log₁₀(T3)” is excessively increased, the amount of the electron-accepting compound incorporated is excessively increased. In addition, ghosting is likely to occur in which, when the same portion on the photoreceptor is continuously exposed, a half-tone image density is increased on only the exposed portion.

“−log₁₀(T3)” in the expression (2) is made to be in the above-described range by controlling, for example, 1) the kind and blending amount of the electron-accepting compound; 2) drying conditions (drying time and drying temperature) of the undercoat layer; 3) the kind of the metal oxide particles; and 4) the amount of a surface treatment agent for the metal oxide particles.

When the undercoat layer has a thickness of 20 μm, a method of measuring the transmittances T1, T2, and T3 of the undercoat layer is as follows.

First, for example, coating films such as a charge generation layer and a charge transport layer which covers the undercoat layer are removed from the electrophotographic photoreceptor using a solvent (for example, acetone, tetrahydrofuran, methanol, or ethanol); and the exposed undercoat layer is peeled off from the conductive substrate to obtain an undercoat layer sample for the measurement.

Next, the undercoat layer sample for the measurement, peeled off from the electrophotographic photoreceptor, is laminated on a glass substrate. Using this glass plate, the optical spectrum of the undercoat layer sample is measured by a spectrophotometer U-2000 (manufactured by Hitachi Ltd.). The absorbance to light having a desired wavelength is obtained from the obtained optical spectrum. Based on this absorbance, the transmittance to the light having the desired wavelength is calculated.

The transmittance T of the undercoat layer having a thickness of 20 μm is calculated according to the following expression (11) from the obtained transmittance t of the undercoat layer sample; and the thickness D (mm) of the undercoat layer sample.

T=10^{(20/D)log}^{₁₀}^{t} Expression (11)

When the transmittance T3 is obtained, the maximum absorption peak wavelength of the electron-accepting compound in a wavelength range from 300 nm to 1000 nm refers to the wavelength which shows the maximum absorbance in the wavelength range.

### Configuration

The undercoat layer includes a binder resin, metal oxide particles, and an electron-accepting compound.

### Binder Resin

Examples of the binder resin include polymer resin compounds such as an acetal resin (for example, polyvinyl butyral), polyvinyl alcohol resin, casein, polyamide resin, cellulosic resin, gelatin, polyurethane resin, polyester resin, methacrylic resin, acrylic resin, polyvinyl chloride resin, polyvinyl acetate resin, vinyl chloride-vinyl acetate-maleic anhydride resin, silicone resin, silicone-alkyd resin, phenol resin, phenol-formaldehyde resin, and melamine resin. In addition, examples thereof also include resins obtained by the reaction of the above-described resins with a curing agent.

### Metal Oxide Particles

Examples of the metal oxide particles include particles of antimony oxide, indium oxide, tin oxide, titanium oxide, and zinc oxide.

Among these, as the metal oxide particles, particles of tin oxide, titanium oxide, and zinc oxide are preferable from the viewpoint of suppressing an increase in residual potential.

As the metal oxide particles, conductive powders of which the particle diameter is preferably less than or equal to 100 nm and more preferably from 10 nm to 100 nm, are used. In this case, the particle diameter represents the average primary particle diameter. The average primary particle diameter of the metal oxide particles is a value obtained by observing and measuring the particles with a scanning electron microscope (SEM).

When the particle diameter of the metal oxide particles is less than 10 nm, the surface areas of the metal oxide particles may increase and the uniformity of a dispersion may deteriorate. On the other hand, when the particle diameter of the metal oxide particles is greater than 100 nm, it is expected that the particle diameter of secondary or higher particles be approximately 1 μm; and a so-called sea-island structure in which there are portions where there are metal oxide particles and portions where there are no metal oxide particles, is likely to be formed in the undercoat layer. As a result, image defects such as unevenness in halftone density may be generated.

It is preferable that the powder resistance of the metal oxide particles is from 10⁴ Ω·cm to 10⁴ Ω·cm. As a result, the undercoat layer is more likely to have appropriate impedance at a frequency corresponding to an electrophotographic process speed.

When the resistance value of the metal oxide particles is less than 10⁴ Ω·cm, the dependence of the impedance on the amount of the particles added may significantly increase and thus the control of the impedance may be difficult. On the other hand, when the resistance value of the metal oxide particles is greater than 10¹⁰ Ω·cm, residual potential may increase.

Optionally, from the viewpoint of improving various properties such as dispersibility, it is preferable that the surfaces of the metal oxide particles be treated with at least one kind of coupling agent.

It is preferable that the coupling agent be at least one selected from a group consisting of silane coupling agents, titanate coupling agents, and aluminate coupling agents.

Specific examples of the coupling agent include silane coupling agents such as vinyl trimethoxy silane, γ-methacryloxypropyl-tris(β-methoxyethoxy)silane, β-(3,4-epoxycyclohexyl)ethyltrimethoxysilane, γ-glycidoxypropyltrimethoxysilane, vinyl triacetoxy silane, γ-mercaptopropyl trimethoxysilane, γ-aminopropyl triethoxysilane, N-β-(aminoethyl)-γ-aminopropyl trimethoxy silane, N-β-(aminoethyl)-γ-aminopropyl methyl dimethoxysilane, N,N-bis(β-hydroxyethyl)-γ-aminopropyl triethoxysilane, and γ-chloropropyl trimethoxysilane; aluminate coupling agents such as acetoalkoxy aluminum diisopropylate; and titanate coupling agents such as isopropyl triisostearoyl titanate, bis(dioctyl pyrophosphate), and isopropyl tri(N-aminoethyl-aminoethyl)titanate. However, the coupling agent is not limited thereto. In addition, as the coupling agent, these examples may be used in a combination of two or more kinds.

The amount of the coupling agent used for the surface treatment is preferably from 0.1% by weight to 3.0% by weight, more preferably from 0.3% by weight to 2.0% by weight, and still more preferably from 0.5% by weight to 1.5% by weight, with respect to the metal oxide particles.

The surface treatment amount of the coupling agent is measured as follows.

There are analysis methods such as a FT-IR method, a solid-state 29 Si NMR method, thermal analysis, and XPS, but the FT-IR method is the simplest way. In the FT-IR method, a well-known KBr tablet method or an ATR method may be used. A small amount of surface-treated metal oxide particles are mixed with KBr for FT-IR measurement. Accordingly, the amount of the coupling agents used for the treatment is measured.

After being treated with the coupling agent, optionally, the surfaces of the metal oxide particles may be thermally treated in order to improve the dependence of the resistance value on environments and the like. It is preferable that the temperature of the thermal treatment be from 150° C. to 300° C. and the treatment time be from 30 minutes to 5 hours.

The content of the metal oxide particles is preferably from 30% by weight to 60% by weight and more preferably from 35% by weight to 55% by weight, from the viewpoint of maintaining electrical characteristics.

### Electron-Accepting Compound

The electron-accepting compound is a material which is chemically reactive with the surfaces of the metal oxide particles included in the undercoat layer or a material which is adsorbed onto the surfaces of the metal oxide particles. The electron-accepting compound may be selectively present on the surfaces of the metal oxide particles.

As the electron-accepting compound, an electron-accepting compound having an acidic group is used. Examples of the acidic group include a hydroxyl group (phenol hydroxyl group), a carboxyl group, and a sulfonyl group.

Specific examples of the electron-accepting compound include quinones, anthraquinones, coumarins, phthalocyanines, triphenylmethanes, anthocyanins, flavones, fullerenes, ruthenium complexes, xanthenes, benzoxazines, and porphyrins.

In particular, anthraquinones (anthraquinone derivatives) are preferable as the electron-accepting compound in consideration of safety, availability, and electron transport capability of a material as well as the suppression of ghost. In particular, it is preferable that the electron-accepting compound is a compound represented by the following formula (1).

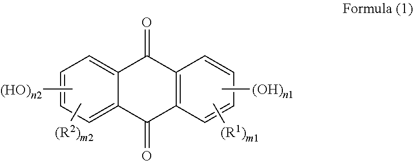

In the formula (1), n1 and n2 each independently represent an integer of from 0 to 3. In this case, at least one of n1 and n2 represents an integer of from 1 to 3 (that is, both n1 and n2 do not represent 0 at the same time). m1 and m2 each independently represent an integer of 0 or 1. R¹ and R² each independently represent an alkyl group having from 1 to 10 carbon atoms or an alkoxy group having from 1 to 10 carbon atoms.

In addition, the electron-accepting compound may be a compound represented by the following formula (2).

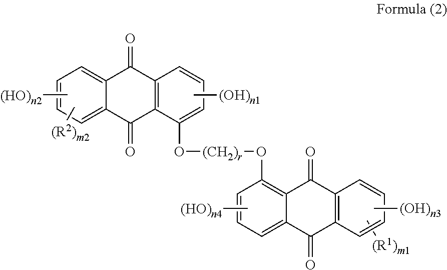

In the formula (2), n1, n2, n3, and n4 each independently represent an integer of 0 to 3, m1 and m2 each independently represent an integer of 0 or 1. At least one of n1 and n2 represents an integer of from 1 to 3 (that is, both n1 and n2 do not represent 0 at the same time). At least one of n3 and n4 represents an integer of from 1 to 3 (that is, both n3 and n4 do not represent 0 at the same time). r represents an integer of from 2 to 10. R¹ and R² each independently represent an alkyl group having from 1 to 10 carbon atoms or an alkoxy group having from 1 to 10 carbon atoms.

Here, in the formulae (1) and (2), the alkyl group having from 1 to 10 carbon atoms represented by R¹ and R² may be linear or branched, and examples thereof include a methyl group, an ethyl group, a propyl group, and an isopropyl group. As the alkyl group having from 1 to 10 carbon atoms, an alkyl group having from 1 to 8 carbon atoms is preferable; and an alkyl group having from 1 to 6 carbon atoms is more preferable.

The alkoxy (alkoxyl) group having from 1 to 10 carbon atoms represented by R¹ and R² may be linear or branched, and examples thereof include a methoxy group, an ethoxy group, a propoxy group, and an isopropoxy group. As the alkoxy group having from 1 to 10 carbon atoms, an alkoxy group having from 1 to 8 carbon atoms is preferable; and an alkoxy group having from 1 to 6 carbon atoms is more preferable.

Specific examples of the electron-accepting compound are shown below, but the electron-accepting compound is not limited to these, examples.

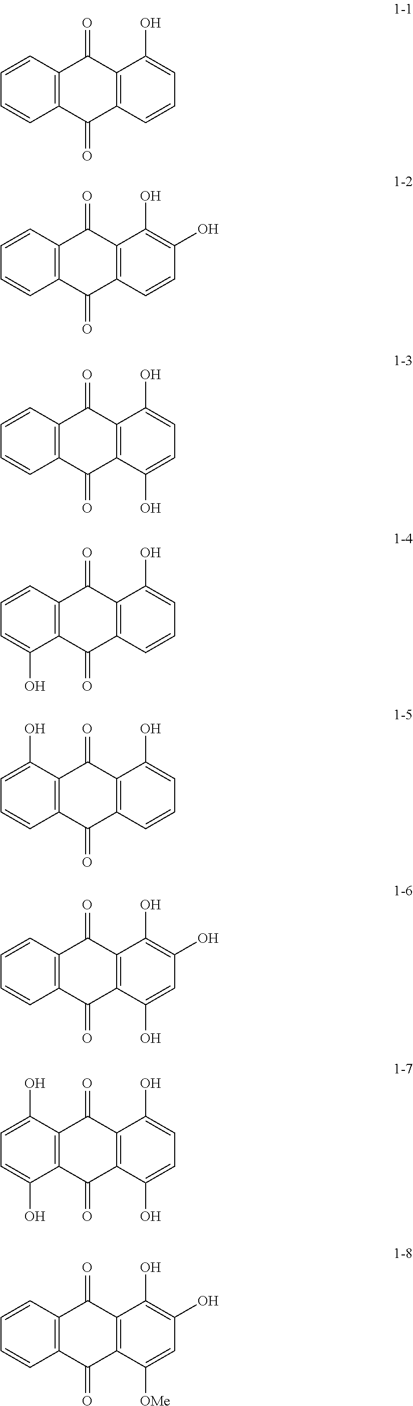

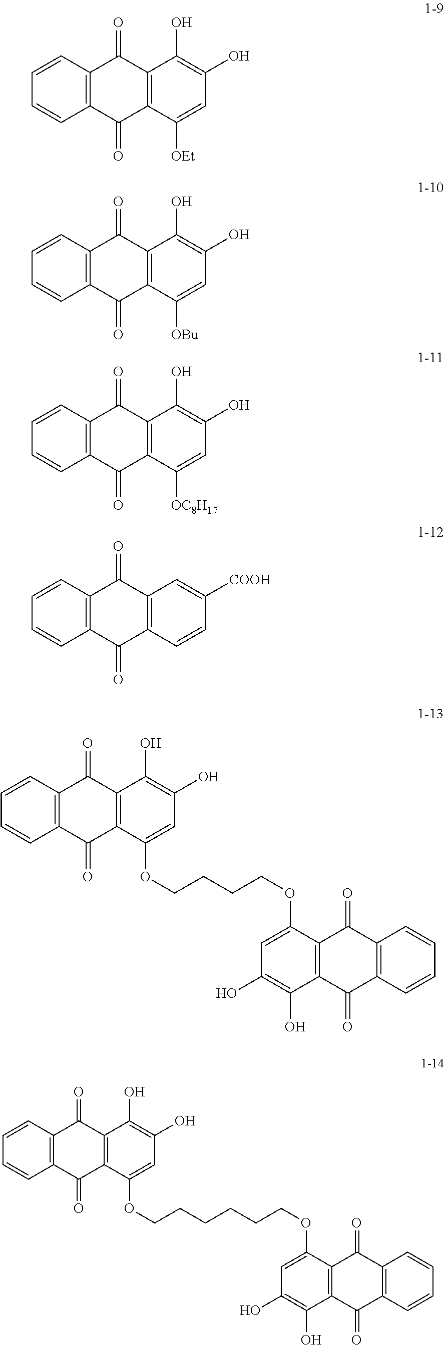

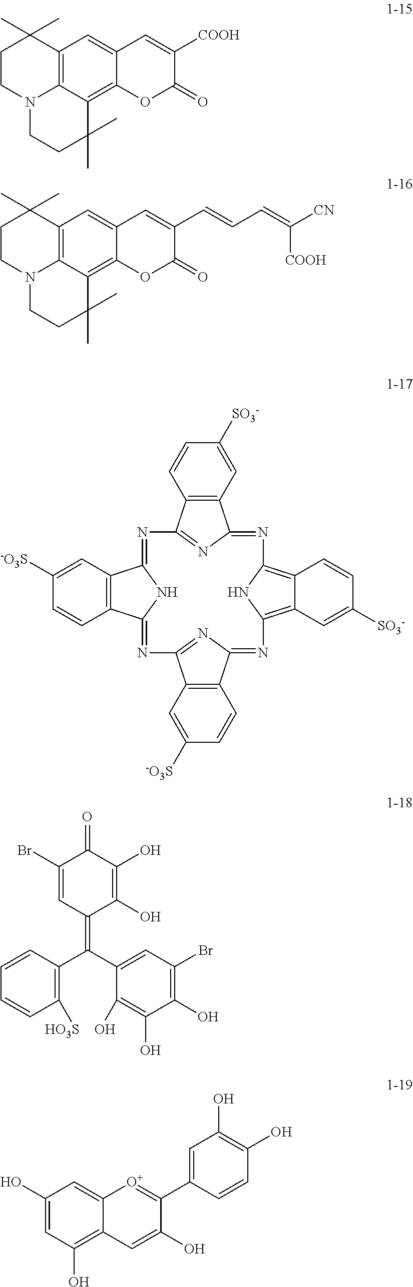

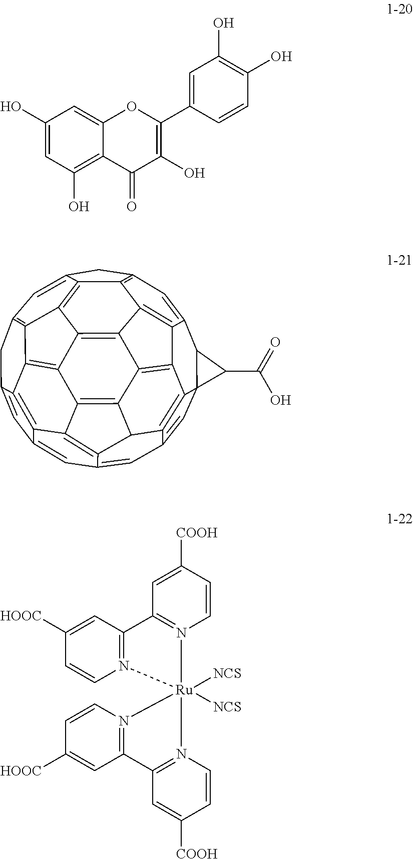

The content of the electron-accepting compound is determined based on the surface area and the content of the metal oxide particles, which is the target of the chemical reaction or the adsorption, and the electron transport capability of each material. In general, the content is preferably from 0.01% by weight to 20% by weight and more preferably from 0.1% by weight to 10% by weight.

When the content of the electron-accepting compound is less than 0.1% by weight, it may be difficult to exhibit an effect of an accepting material. On the other hand, when the content of the electron-accepting compound is greater than 20% by weight, the aggregation between the metal oxide particles is likely to occur. Therefore, the metal oxide particles are likely to be unevenly distributed in the undercoat layer and it may be difficult to form a highly conductive path. As a result, a residual potential increases, ghosting occurs, and furthermore dark spots and unevenness in halftone density may occur.

The content of the electron-accepting compound is controlled so as to satisfy the expression (2).

### Other Additives

An example of other additives includes resin particles. When coherent light such as laser light is used in an exposure device, it is preferable that moire fringes be prevented. To that end, it is preferable that the surface roughness of the undercoat layer be adjusted to be from ¼n (n represents the refractive index of an upper layer) to ½λ of a wavelength λ of exposure laser light which is used. In this case, the surface roughness may be adjusted by adding resin particles to the undercoat layer. Examples of the resin particles include silicone resin particles and cross-linked polymethyl methacrylate (PMMA) resin particles.

In addition, other additives are not limited to the above-described examples and well-known additives may be used.

### Formation of Undercoat Layer

When the undercoat layer is formed, an undercoat-layer-forming coating solution in which the above-described components are added to a solvent, is used. The undercoat-layer-forming coating solution is obtained by, for example, preliminarily mixing or dispersing the metal oxide particles and optionally, the electron-accepting compound and other additives and dispersing the resultant in the binder resin.

Examples of the solvent used for obtaining the undercoat-layer-forming coating solution include well-known organic solvents for dissolving the above-described binder resin, such as alcohol solvents, aromatic solvents, halogenated hydrocarbon solvents, ketone solvents, ketone alcohol solvents, ether solvents, and ester solvents. As the solvent, these examples may be used alone or as a mixture or two or more kinds.

Examples of a method of dispersing the metal oxide particles in the undercoat-layer-forming coating solution include well-known dispersing methods such as methods using a roll mill, a ball mill, a vibration ball mill, an attritor, a sand mill, a colloid mill and a paint shaker.

Examples of a coating method of the undercoat-layer-forming coating solution include well-known coating methods such as a dip coating method, a blade coating method, a wire-bar coating method, a spray coating method, a bead coating method, an air knife coating method, and a curtain coating method.

It is preferable that the Vickers hardness of the undercoat layer be from 35 to 50.

The thickness of the undercoat layer is preferably greater than or equal to 15 μm, more preferably from 15 μm to 30 μm, and still more preferably from 20 μm to 25 μm, from the viewpoint of suppressing an increase in residual potential.

### Intermediate Layer

The intermediate layer may optionally be provided, for example, between the undercoat layer and the photosensitive layer in order to improve electrical characteristics, image quality, image quality maintainability, and photosensitive layer adhesion. In addition, the intermediate layer may be provided between the conductive substrate and the undercoat layer.

Examples of a binder resin used for the intermediate layer include polymer resin compounds such as an acetal resin (for example, polyvinyl butyral), polyvinyl alcohol resin, casein, polyamide resin, cellulosic resin, gelatin, polyurethane resin, polyester resin, methacrylic resin, acrylic resin, polyvinyl chloride resin, polyvinyl acetate resin, vinyl chloride-vinyl acetate-maleic anhydride resin, silicone resin, silicone-alkyd resin, phenol-formaldehyde resin, and melamine resin; and organometallic compounds containing atoms of zirconium, titanium, aluminum, manganese, silicon, or the like. These compounds may be used alone or as a mixture or a polycondensate of plural compounds. Among these, organometallic compounds containing atoms of zirconium or silicon are preferable from the viewpoints of low residual potential, less potential change depending on environments, and less potential change due to repetitive use.

When the intermediate layer is formed, an intermediate-layer-forming coating solution in which the above-described components are added to a solvent, is used.

Examples of a coating method for forming the intermediate layer include well-known methods such as a dip coating method, a push-up coating method, a wire-bar coating method, a spray coating method, a blade coating method, a knife coating method, and a curtain coating method.

The intermediate layer has a function as an electric blocking layer in addition to a function of improving the coating property of an upper layer. However, when the thickness of the layer is too large, an electrical barrier works strongly, which may lead to desensitization or potential increase due to repetitive use. Therefore, when the intermediate layer is formed, it is preferable that the thickness of the intermediate layer be from 0.1 μm to 3 μm. In addition, the intermediate layer at this time may be used as the undercoat layer.

Charge Generation layer

The charge generation layer includes, for example, a charge generation material and a binder resin. In addition, the charge generation layer may be configured as a vapor deposited film of the charge generation material.

Examples of the charge generation material include phthalocyanine pigments such as metal-free phthalocyanine, chlorogallium phthalocyanine, hydroxygallium phthalocyanine, dichlorotin phthalocyanine, and titanyl phthalocyanine. In particular, for example, a chlorogallium phthalocyanine crystal having distinct diffraction peaks at Bragg angles (2θ±0.2°) with respect to CuKα characteristic X-rays of at least 7.4°, 16.6°, 25.5°, and 28.3°; a metal-free phthalocyanine crystal having distinct diffraction peaks at Bragg angles (2θ±0.2°) with respect to CuKα characteristic X-rays of at least 7.7°, 9.3°, 16.9°, 17.5°, 22.4°, and 28.8°; a hydroxygallium phthalocyanine crystal having distinct diffraction peaks at Bragg angles (2θ±0.2°) with respect to CuKα characteristic X-rays of at least 7.5°, 9.9°, 12.5°, 16.3°, 18.6°, 25.1°, and 28.3°; and a titanyl phthalocyanine crystal having distinct diffraction peaks at Bragg angles (2θ±0.2°) with respect to CuKα characteristic X-rays of at least 9.6°, 24.1°, and 27.2°. Furthermore, examples of the charge generation material include quinone pigments, perylene pigments, indigo pigments, bisbenzimidazole pigments, anthrone pigments, and quinacridone pigments. In addition, as the charge generation material, these examples may be used alone or as a mixture of two or more kinds.

Examples of the binder resin constituting the charge generation layer include bisphenol A type or bisphenol Z type polycarbonate resin, acrylic resin, methacrylic resin, polyarylate resin, polyester resin, polyvinyl chloride resin, polystyrene resin, acrylonitrile-styrene copolymer resin, acrylonitrile-butadiene copolymer resin, polyvinyl acetate resin, polyvinyl formal resin, polysulfone resin, styrene-butadiene copolymer resin, vinylidene chloride-acrylonitrile copolymer resin, vinyl chloride-vinyl acetate-maleic anhydride resin, silicone resin, phenol-formaldehyde resin, polyacrylamide resin, polyamide resin, and poly-N-vinylcarbazole resin. As the binder resin, these examples may be used alone or as a mixture of two or more kinds.

It is preferable that the mixing ratio of the charge generation material and the binder resin be, for example, from 10:1 to 1:10.

When the charge generation layer is formed, a charge-generation-layer-forming coating solution in which the above-described components are added to a solvent, is used.

Examples of a method of dispersing particles (for example, particles of the charge generation material) in the charge-generation-layer-forming coating solution, include methods using medium dispersing machines such as a ball mill, a vibration ball mill, an attritor, a sand mill, and a horizontal sand mill; and mediumless dispersing machines such as a stirrer, an ultrasonic wave disperser, a roll mill, and a high-pressure homogenizer. Examples of the high-pressure homogenizer include a collision type of dispersing a dispersion in high-pressure state through liquid-liquid collision or liquid-wall collision; and a pass-through type of dispersing a dispersion by causing it to pass through a fine flow path in a high-pressure state.

Examples of a method of coating the undercoat layer with the charge-generation-layer-forming coating solution include a dip coating method, a push-up coating method, a wire-bar coating method, a spray coating method, a blade coating method, a knife coating method, and a curtain coating method.

The thickness of the charge generation layer is set in a range of preferably from 0.01 μm to 5 μm and more preferably from 0.05 μm to 2.0 μm.

### Charge Transport Layer

The charge transport layer includes a charge transport material and optionally, a binder resin.

Examples of the charge transport material include hole transport materials such as oxadiazole derivatives (for examples, 2,5-bis(p-diethylaminophenyl)-1,3,4-oxadiazole), pyrazoline derivatives (for example, 1,3,5-triphenyl-pyrazoline and 1-[pyridyl-(2)]-3-(p-diethylaminostyryl)-5-(p-diethylamino styryl)pyrazoline), aromatic tertiary amino compounds (for example, triphenylamine, N—N′-bis(3,4-dimethylphenyl)biphenyl-4-amine, trip-methylphenyl)aminyl-4-amine, and dibenzyl aniline), aromatic tertiary diamino compounds (for example, N,N′-bis(3-methylphenyl)-N,N′-diphenyl benzidine), 1,2,4-triazine derivatives (for example, 3-(4′-dimethylaminophenyl)-5,6-di-(4′-methoxyphenyl)-1,2,4-triazine), hydrazone derivatives (for example, 4-diethylaminobenzaldehyde-1,1-diphenyl hydrazone), quinazoline derivatives (for example, 2-phenyl-4-styryl-quinazoline), benzofuran derivatives (for example, 6-hydroxy-2,3-di(p-methoxyphenyl)benzofuran), α-stilbene derivatives (for example, p-(2,2-diphenylvinyl)-N,N-diphenyl aniline), enamine derivatives, and carbazole derivatives (for example, N-ethylcarbazole), and poly-N-vinylcarbazole and derivatives thereof; electron transport materials such as quinone compounds (for example, chloranil and bromoanthraquinone), tetracyanoquinodimethane compounds, fluorenone compounds (for example, 2,4,7-trinitrofluorenone and 2,4,5,7-tetranitro-9-fluororenone), xanthone compounds, and thiophene compounds; and polymers having a group which includes the above-mentioned compounds in the main chain or a side chain thereof. As the charge transport material, these examples may be used alone or in a combination of two or more kinds.

Examples of the binder resin constituting the charge transport layer include insulating resins such as bisphenol A type or bisphenol Z type polycarbonate resin, acrylic resin, methacrylic resin, polyarylate resin, polyester resin, polyvinyl chloride resin, polystyrene resin, acrylonitrile-styrene copolymer resin, acrylonitrile-butadiene copolymer resin, polyvinyl acetate resin, polyvinyl formal resin, polysulfone resin, styrene-butadiene copolymer resin, vinylidene chloride-acrylonitrile copolymer resin, vinyl chloride-vinyl acetate-maleic anhydride resin, silicone resin, phenol-formaldehyde resin, polyacrylamide resin, polyamide resin, and chlorine rubber; organic photoconductive polymers such as polyvinyl carbazole, polyvinyl anthracene, and polyvinyl pyrene. As the binder resin, these examples may be used alone or as a mixture of two or more kinds.

It is preferable that the mixing ratio of the charge transport material and the binder resin be, for example, from 10:1 to 1:5.

The charge transport layer is formed using a charge-transport-layer-forming coating solution in which the above-described components are added to a solvent.

Examples of a method of coating the charge generation layer with the charge-transport-layer-forming coating solution include well-known methods such as a dip coating method, a push-up coating method, a wire-bar coating method, a spray coating method, a blade coating method, a knife coating method, and a curtain coating method.

The thickness of the charge transport layer is set in a range of preferably from 5 μm to 50 μm and more preferably from 10 μm to 40 μm.

### Protective Layer

The protective layer is optionally provided on the photosensitive layer. The protective layer is provided in order to prevent the chemical change of the charge transport layer, when being charged, in the photoreceptor having a laminated structure and to further improve the mechanical strength of the photosensitive layer.

Accordingly, it is preferable that a layer containing a cross-linked substance (hardened substance) be used as the protective layer. Configuration examples of the layer include well-known layer configurations such as a hardened layer having a composition which contains a reactive charge transport material and optionally a hardening resin; and a hardened layer in which the charge transport material is dispersed in a hardening resin. In addition, as the protective layer, a layer in which the charge transport material is dispersed in the binder resin may be used.

The protective layer is formed using a protective-layer-forming coating solution in which the above-described components are added to a solvent.

Examples of a method of coating the charge generation layer with the protective-layer-forming coating solution includes well-known methods such as a dip coating method, a push-up coating method, a wire-bar coating method, a spray coating method, a blade coating method, a knife coating method, and a curtain coating method.

The thickness of the protective layer is set in a range of preferably from 1 μm to 20 μm and more preferably from 2 μm to 10 μm.

Single-Layered Photosensitive Layer

A single-layered photosensitive layer (charge generation and charge transport layer) may include, for example, a binder resin, a charge generation material, and a charge transport material. These materials are the same as the above-described materials used in the charge generation layer and the charge transport layer.

In the single-layered photosensitive layer, the content of the charge generation material is preferably from 10% by weight to 85% by weight and more preferably from 20% by weight to 50% by weight. In addition, the content of the charge transport material is preferably from 5% by weight to 50% by weight.

A method of forming the single-layered photosensitive layer is the same as the method of forming the charge generation layer or the charge transport layer. The thickness of the single-layered photosensitive layer is preferably from 5 μm to 50 μm and more preferably from 10 μm to 40 μm.

### Others

In the electrophotographic photoreceptor according to the exemplary embodiment, in order to prevent the photoreceptor from deteriorating due to ozone and oxidized gas generated in an image forming apparatus, or light and heat, additives such as an antioxidant, a light stabilizer, and a heat stabilizer may be added to the photosensitive layer or the protective layer.

In addition, in order to increase sensitivity and to reduce residual potential and fatigue due to repetitive use, at least one electron-accepting material may be added to the photosensitive layer or the protective layer.

In addition, in the photosensitive layer or the protective layer, silicone oil may be added to the coating solutions for forming the respective layers as a leveling agent to improve the smoothness of a coating layer.

### Image Forming Apparatus

Next, an image forming apparatus according to the exemplary embodiment will be described.

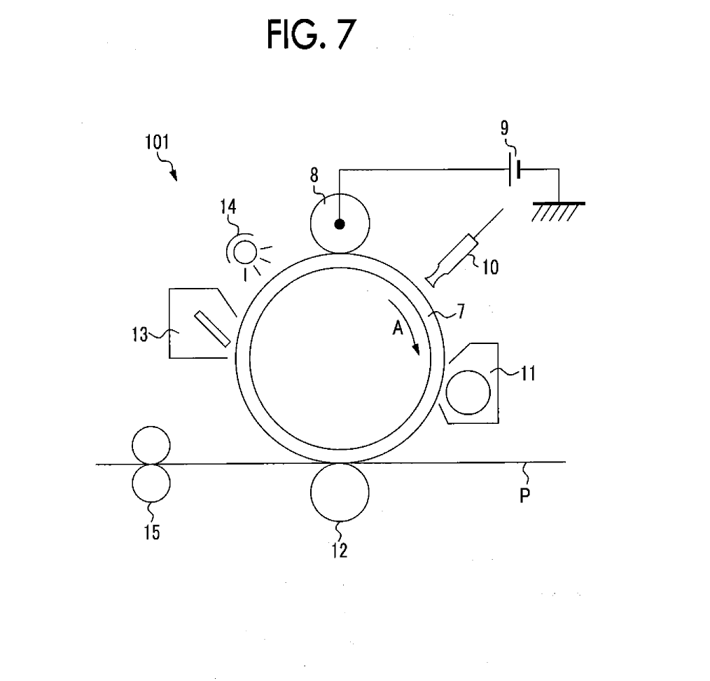

FIG. 7 is a diagram schematically illustrating an example of an image forming apparatus according to the exemplary embodiment. An image forming apparatus 101 shown in FIG. 7 includes a drum-shaped (cylindrical) electrophotographic photoreceptor 7 according to the exemplary embodiment, for example, which is rotatably provided. Around the electrophotographic photoreceptor 7, for example, a charging device 8, an exposure device 10, a developing device 11, a transfer device 12, a cleaning device 13 and an erasing device 14 are disposed in this order along a moving direction of the outer circumferential surface of the electrophotographic photoreceptor 7. The cleaning device 13 and the erasing device 14 are optionally provided.

### Charging Device

The charging device 8 is connected to a power supply 9 and charges the surface of the electrophotographic photoreceptor 7 using voltage applied from the power supply 9.

Examples of the charging device 8 include contact charging devices using a charging roller, a charging brush, a charging film, a charging rubber blade, a charging tube, and the like which are conductive. In addition, examples of the charging device B include non-contact roller charging devices and well-known charging devices such as a scorotron charger or corotron charger using corona discharge. As the charging device 8, contact charging devices are preferable.

### Exposure Device

The exposure device 10 forms an electrostatic latent image on the electrophotographic photoreceptor 7 by exposing the charged electrophotographic photoreceptor 7 to light.

Examples of the exposure device 10 include optical devices in which the surface of the electrophotographic photoreceptor 7 is imagewise exposed to light such as semiconductor laser light, LED light, and liquid crystal shutter light. It is preferable that the wavelength of a light source fall within the spectral sensitivity range of the electrophotographic photoreceptor 7. It is preferable that the wavelength of a semiconductor laser light be, for example, in the near-infrared range having an oscillation wavelength of about 780 nm. However, the wavelength is not limited thereto. Laser light having an oscillation wavelength of about 600 nm or laser light having an oscillation wavelength of 400 nm to 450 nm as blue laser light may be used. In addition, in order to form a color image, as the exposure device 10, for example, a surface-emitting laser light source which emits multiple beams is also effective.

### Developing Device

The developing device 11 forms a toner image by developing the electrostatic latent image using a developer. It is preferable that the developer include toner particles with a volume average particle diameter of 3 μm to 9 μm which is obtained by polymerization. The developing device 11 has, for example, a configuration which includes a developing roller disposed opposite the electrophotographic photoreceptor 7 in a developing range, in a container containing a two-component developer which includes toner and a carrier.

### Transfer Device

The transfer device 12 transfers the toner image, which is developed on the electrophotographic photoreceptor 7, onto a transfer medium.

Examples of the transfer device 12 include contact transfer charging devices using a belt, a roller, a film, a rubber blade, and the like; and well-known transfer charging devices such as scorotron transfer charger or corotron transfer charger using corona discharge.

### Cleaning Device

The cleaning device 13 removes toner remaining on the electrophotographic photoreceptor 7 after transfer.

It is preferable that the cleaning device 13 include a cleaning blade which is in contact with the electrophotographic photoreceptor 7 at a linear pressure of from 10 g/cm to 150 g/cm. The cleaning device 13 includes, for example, a case, a cleaning blade, and a cleaning brush which is disposed downstream of the cleaning blade in a rotating direction of the electrophotographic photoreceptor V. In addition, for example, a solid lubricant is disposed in contact with the cleaning brush.

### Erasing Device

The erasing device 14 erases a potential remaining on the surface of the electrophotographic photoreceptor by irradiating the surface of the electrophotographic photoreceptor 7 with erasing light after the toner image is transferred. For example, the erasing device 14 removes the difference between potentials of an exposed portion and an unexposed portion which is generated on the surface of the electrophotographic photoreceptor 7 by the exposure device 10, by irradiating the entire area of the electrophotographic photoreceptor 7 with erasing light in an axial direction and a width direction.

A light source of the erasing device 14 is not particularly limited, and examples thereof include a tungsten lamp (for example, white light) and a light emitting diode (LED; for example, red light).

### Fixing Device

The image forming apparatus 101 includes a fixing device 15 which fixes the toner image on a recording paper P after the transfer process. The fixing device is not particularly limited and examples thereof include well-known fixing devices such as a heat roller fixing device and an oven fixing device.

Next, the operations of the image forming apparatus 101 according to the exemplary embodiment will be described. First, the electrophotographic photoreceptor 7 is charged to a negative potential by the charging device 8 while rotating along a direction indicated by arrow A.

The surface of the electrophotographic photoreceptor 7, which is charged to a negative potential by the charging device 8, is exposed to light by the exposure device 10 and an electrostatic latent image is formed thereon.

When a portion of the electrophotographic photoreceptor 7, where the electrostatic latent image is formed, approaches the developing device 11, toner is attached onto the electrostatic latent image by the developing device 11 and thus a toner image is formed.

When the electrophotographic photoreceptor 7 where the toner image is formed further rotates in the direction indicated by arrow A, the toner image is transferred onto the recording paper P by the transfer device 12. As a result, the toner image is formed on the recording paper P.

The toner image, which is formed on the recording paper P, is fixed on the recording paper P by the fixing device 15.

### Process Cartridge

The image forming apparatus according to the exemplary embodiment may be configured such that, for example, a process cartridge which includes the electrophotographic photoreceptor 7 according to the exemplary embodiment is detachable from the image forming apparatus.

The process cartridge according to the exemplary embodiment is not limited as long as it includes at least the electrophotographic photoreceptor 7 according to the exemplary embodiment. For example, in addition to the electrophotographic photoreceptor 7, the process cartridge may further include at least one component selected from the charging device 8, the exposure device 10, the developing device 11, the transfer device 12, the cleaning device 13, and the erasing device 14.

In addition, the image forming apparatus according to the exemplary embodiment is not limited to the above-described configurations. For example, in the vicinity of the electrophotographic photoreceptor 7, a first erasing device for aligning the polarity of remaining toner and facilitating the cleaning brush to remove the remaining toner may be provided downstream of the transfer device 12 in the rotating direction of the electrophotographic photoreceptor 7 and upstream of the cleaning device 13 in the rotating direction of the electrophotographic photoreceptor 7; or a second erasing device for erasing the charge on the surface of the electrophotographic photoreceptor 7 may be provided downstream of the cleaning device 13 in the rotating direction of the electrophotographic photoreceptor 7 and upstream of the charging device 8 in the rotating direction of the electrophotographic photoreceptor 7.

In addition, the image forming apparatus according to the exemplary embodiment is not limited to the above-described configurations and well-known configurations may be adopted. For example, an intermediate transfer type image forming apparatus, in which the toner image, which is formed on the electrophotographic photoreceptor 7, is transferred onto an intermediate transfer medium and then transferred onto the recording paper P, may be adopted; or a tandem-type image forming apparatus may be adopted.

The electrophotographic photoreceptor according to the exemplary embodiment may be applied to an image forming apparatus which does not include the erasing device.

### EXAMPLES

Hereinafter, the exemplary embodiment will be described in detail with reference to Examples and Comparative Examples but is not limited to the Examples below.

### Example 1

100 parts by weight of zinc oxide (trade name: MZ-300, manufactured by Tayca Corporation) as the metal oxide particles, 10 parts by weight of 10% by weight toluene solution of γ-aminopropyl triethoxysilane (hereinafter, also referred to as “γ-APTES”) as a coupling agent, and 200 parts by weight of toluene are mixed and stirred, followed by reflux for 2 hours. Then, toluene is removed by distillation under reduced pressure at 10 mmHg, followed by baking at 135° C. for 2 hours.

33 parts by weight of zinc oxide with the particles of which the surfaces are treated, 6 parts by weight of blocked isocyanate (SUMIDUR 3175, manufactured by Sumitomo Bayer Urethane Co., Ltd.), 0.7 part by weight of electron-accepting compound (Exemplary Compound (1-2)), and 25 parts by weight of methyl ethyl ketone are mixed for 30 minutes. Then, 5 parts by weight of butyral resin S-LEC BM-1 (manufactured by SEKISUI CHEMICAL CO., LTD.), 3 parts by weight of silicone balls (TOSPEARL 130, manufactured by GE Toshiba Silicone Co., Ltd.), and 0.01 part by weight of silicone oil (SH29PA, manufactured by Dow Corning Toray Silicone Co., Ltd.) as a leveling agent are added thereto, followed by dispersion using a sand mill for 2 hours. As a result, a dispersion (undercoat-layer-forming coating solution) is obtained.

Furthermore, an aluminum substrate having a diameter of 30 mm, a length of 404 mm, and a thickness of 1 mm is coated with this coating solution using a dip coating method, and the coating solution is dried and hardened at 180° C. for 30 minutes. As a result, an undercoat layer having a thickness of 20 μm is obtained.

Next, a mixture of 15 parts by weight of hydroxygallium phthalocyanine as the charge generation material, 10 parts by weight of vinyl chloride-vinyl acetate copolymer resin (VMCH, manufactured by Nippon Unicar Co., Ltd.), and 300 parts by weight of n-butyl alcohol is dispersed for 4 hours using a sand mill. The obtained dispersion is dip-coated on the undercoat layer, followed by drying at 100° C. for 10 minutes. As a result, a charge generation layer having a thickness of 0.2 μm is formed.

Furthermore, a coating solution, in which 4 parts by weight of N—N-diphenyl-N,N′-bis(3-methylphenyl)-[1,1′]biphenyl-4,4′-diamine, and 6 parts by weight of bisphenol Z polycarbonate resin (viscosity average molecular weight: 40,000) are added to 25 parts by weight of tetrahydrofuran and 5 parts by weight of chlorobenzene and dissolved therein, is coated on the charge generation layer, followed by drying at 130° C. for 40 minutes. As a result, a charge transport layer having a thickness of 35 μl is formed.

Through the above-described processes, a photoreceptor is obtained.

In the obtained photoreceptor, the transmittances T1, T2, and T3 to light rays having the respective wavelengths of the undercoat layer are measured according to the above-described method. The results are shown in Table 1.

The maximum absorption peak wavelength of the electron-accepting compound (Exemplary Compound (1-2)) is 550 nm. The transmittance T3 is measured as the transmittance to light having a wavelength of 550 nm.

In addition, the obtained photoreceptor is mounted onto a copying machine “DocuCentre A450” (manufactured by Fuji Xerox Co., Ltd.; apparatus including a contact type charging roll as the charging device); and is evaluated as follows. The results are shown in Table 1.

### Evaluation for Fogging

Fogging is evaluated with a method in which a solid image having a size of 1 cm×10 cm and an image density of 100% is continuously printed on 300,000 sheets of paper, fed in a width direction of A4 paper, in an environment of 28° C. and 80% RH. The 1st-printed image (initial stage) and the 300,000th-printed image (after printing 300,000 images) are evaluated by visual inspection.

The evaluation criteria are as follows.

A: No fogging is observed
B: A small amount of fogging is observed
C: Fogging is observed

### Evaluation for Residual Potential

The residual potential of the photoreceptor obtained in each example is measured as follows.

Using a copying machine “DocuCentre A450” (manufactured by Fuji Xerox Co., Ltd.), a potential measuring probe is installed at a portion of the developing roller; and the surface potential of the photoreceptor after erasing is obtained as the residual potential.

After the completion of the evaluation for fogging (after printing 300,000 images), the above-described measurement is performed to obtain a residual potential. A difference between the obtained residual potential and the initial-stage residual potential is obtained as an increase in residual potential and is evaluated for residual potential.

The evaluation criteria are as follows.

A: A change in residual potential is less than or equal to 30 V
B: A change in residual potential is greater than 30 V and less than or equal to 60 V
C: A change in residual potential is greater than 60 V

### Comparative Example 1

A photoreceptor is prepared with the same method as that of Example 1, except that the dispersion time (dispersion time of zinc oxide as the metal oxide particles) of the dispersion (undercoat-layer-forming coating solution) is changed to 15 minutes. The same evaluations are performed using this photoreceptor. The results are shown in Table

### Comparative Example 2

A photoreceptor is prepared with the same method as that of Example 1, except that the dispersion time (dispersion time of zinc oxide as the metal oxide particles) of the dispersion (undercoat-layer-forming coating solution) is changed to 5 hours. The same evaluations are performed using this photoreceptor. The results are shown in Table

### Comparative Example 3

A photoreceptor is prepared with the same method as that of Example 1, except that the amount of the electron-accepting compound (Exemplary Compound (1-2)) added is changed to 0.1 part by weight. The same evaluations are performed using this photoreceptor. The results are shown in Table 1.

### Example 2

A photoreceptor is prepared with the same method as that of Example 1, except that titanium oxide is used as the metal oxide particles. The same evaluations are performed using this photoreceptor. The results are shown in Table 1.

### Example 3

A photoreceptor is prepared with the same method as that of Example 1, except that tin oxide is used as the metal oxide particles. The same evaluations are performed using this photoreceptor. The results are shown in Table 1.

### Example 4

A photoreceptor is prepared with the same method as that of Example 1, except that Exemplary Compound (1-8) is used as the electron-accepting compound. The same evaluations are performed using this photoreceptor. The results are shown in Table 1.

The maximum absorption peak wavelength of the electron-accepting compound (Exemplary compound (1-8)) is 535 nm. The transmittance T3 is measured as the transmittance to light having a wavelength of 535 nm.

### Example 5

A photoreceptor is prepared with the same method as that of Example 1, except that Exemplary Compound (1-14) is used as the electron-accepting compound. The same evaluations are performed using this photoreceptor. The results are shown in Table 1.

The maximum absorption peak wavelength of the electron-accepting compound (Exemplary compound (1-14)) is 540 nm. The transmittance T3 is measured as the transmittance to light having a wavelength of 540 nm.

### Example 6

A photoreceptor is prepared with the same method as that of Example 1, except that Exemplary Compound (1-21) is used as the electron-accepting compound. The same evaluations are performed using this photoreceptor. The results are shown in Table 1.

The maximum absorption peak wavelength of the electron-accepting compound (Exemplary compound (1-21)) is 520 nm. The transmittance T3 is measured as the transmittance to light having a wavelength of 520 nm.

### Comparative Example 4

A photoreceptor is prepared with the same method as that of Example 1, except that the electron-accepting compound is not added. The same evaluations are performed using this photoreceptor. The results are shown in Table 1.

### Example 7

A photoreceptor is prepared with the same method as that of Example 1, except that the dispersion time is changed to 3 hours; and the amount of the electron-accepting compound added is changed to 0.5 part by weight. The same evaluations are performed using this photoreceptor. The results are shown in Table 1.

### Example 8

A photoreceptor is prepared with the same method as that of Example 1, except that the dispersion time is changed to 1 hour; and the amount of the electron-accepting compound added is changed to 0.5 part by weight. The same evaluations are performed using this photoreceptor. The results are shown in Table 1.

### Example 9

A photoreceptor is prepared with the same method as that of Example 1, except that the dispersion time is changed to 3 hours; and the amount of the electron-accepting compound added is changed to 1.5 parts by weight. The same evaluations are performed using this photoreceptor. The results are shown in Table 1.

### Example 10

A photoreceptor is prepared with the same method as that of Example 1, except that the dispersion time is changed to 1 hour; and the amount of the electron-accepting compound added is changed to 1.5 parts by weight. The same evaluations are performed using this photoreceptor. The results are shown in Table 1.

### Example 11

A photoreceptor is prepared with the same method as that of Example 1, except that the amount of the electron-accepting compound added is changed to 3.5 parts by weight. The same evaluations are performed using this photoreceptor. The results are shown in Table 1.

### Comparative Example 5

A photoreceptor is prepared with the same method as that of Example 1, except that the dispersion time is changed to 5 hours; and the amount of the electron-accepting compound added is changed to 0.1 part by weight. The same evaluations are performed using this photoreceptor. The results are shown in Table 1.

### Comparative Example 6

A photoreceptor is prepared with the same method as that of Example 1, except that the dispersion time is changed to 3 hours; and the amount of the electron-accepting compound added is changed to 0.1 part by weight. The same evaluations are performed using this photoreceptor. The results are shown in Table 1.

### Comparative Example 7

A photoreceptor is prepared with the same method as that of Example 1, except that the dispersion time is changed to 1 hour; and the amount of the electron-accepting compound added is changed to 0.1 part by weight. The same evaluations are performed using this photoreceptor. The results are shown in Table 1.

### Comparative Example 8

A photoreceptor is prepared with the same method as that of Example 1, except that the dispersion time is changed to 15 minutes; and the amount of the electron-accepting compound added is changed to 0.5 part by weight. The same evaluations are performed using this photoreceptor. The results are shown in Table 1.

### Comparative Example 9

A photoreceptor is prepared with the same method as that of Example 1, except that the dispersion time is changed to 15 minutes; and the amount of the electron-accepting compound added is changed to 0.1 part by weight. The same evaluations are performed using this photoreceptor. The results are shown in Table 1.

### Comparative Example 10

A photoreceptor is prepared with the same method as that of Example 1, except that the dispersion time is changed to 5 hours; and the amount of the electron-accepting compound added is changed to 0.5 part by weight. The same evaluations are performed using this photoreceptor. The results are shown in Table 1.

### Comparative Example 11

A photoreceptor is prepared with the same method as that of Example 1, except that the dispersion time is changed to 5 hours; and the amount of the electron-accepting compound added is changed to 0.1 part by weight. The same evaluations are performed using this photoreceptor. The results are shown in Table 1.

### Comparative Example 12

A photoreceptor is prepared with the same method as that of Example 1, except that the dispersion time is changed to 5 hours; and the amount of the electron-accepting compound added is changed to 1.5 parts by weight. The same evaluations are performed using this photoreceptor. The results are shown in Table 1.

### Comparative Example 13

A photoreceptor is prepared with the same method as that of Example 1, except that the dispersion time is changed to 15 minutes; and the amount of the electron-accepting compound added is changed to 1.5 parts by weight. The same evaluations are performed using this photoreceptor. The results are shown in Table 1.

### Comparative Example 14

A photoreceptor is prepared with the same method as that of Example 1, except that the surfaces of the metal oxide particles are not treated. The same evaluations are performed using this photoreceptor. The results are shown in Table 1.

TABLE 1

| | Composition of Undercoat Layer | | | Characteristics of | | Evaluation | | | |
|---|---|---|---|---|---|---|---|---|---|
| | Metal Oxide Particles | | Electron- | Undercoat Layer | | Fogging | | Residual Potential | |
| | | Surface | Accepting | | −log₁₀ | Initial | After Printing | Initial | After Printing |
| | Material | Treatment Agent | Compound | T1/T2 | (T3) | Stage | 300,000 images | Stage | 300,000 images |
| Example 1 | ZnO | γ-APTES | 1-2 | 20 | 0.31 | A | A | A | A |
| Example 2 | TiO₂ | γ-APTES | 1-2 | 19 | 0.31 | A | B | A | B |
| Example 3 | SnO₂ | γ-APTES | 1-2 | 22 | 0.29 | A | B | A | B |
| Example 4 | ZnO | γ-APTES | 1-8 | 21 | 0.34 | A | A | A | A |
| Example 5 | ZnO | γ-APTES | 1-14 | 18 | 0.31 | A | A | A | A |
| Example 6 | ZnO | γ-APTES | 1-21 | 20 | 0.29 | A | A | A | A |
| Example 7 | ZnO | γ-APTES | 1-2 | 7 | 0.28 | A | A | A | A |
| Example 8 | ZnO | γ-APTES | 1-2 | 37 | 0.29 | A | A | A | A |
| Example 9 | ZnO | γ-APTES | 1-2 | 6 | 0.9 | A | A | A | A |
| Example 10 | ZnO | γ-APTES | 1-2 | 39 | 0.9 | A | A | A | A |
| Example 11 | ZnO | γ-APTES | 1-2 | 22 | 2.1 | A | A | A | A |
| Comparative Example 1 | ZnO | γ-APTES | 1-2 | 45 | 0.33 | B | C | A | A |
| Comparative Example 2 | ZnO | γ-APTES | 1-2 | 0.5 | 0.32 | A | A | B | C |
| Comparative Example 3 | ZnO | γ-APTES | 1-2 | 21 | 0.20 | A | A | B | C |
| Comparative Example 4 | ZnO | γ-APTES | None | 22 | 0.08 | A | A | C | C |
| Comparative Example 5 | ZnO | γ-APTES | 1-2 | 2 | 0.2 | B | C | C | C |
| Comparative Example 6 | ZnO | γ-APTES | 1-2 | 6 | 0.23 | A | A | C | C |
| Comparative Example 7 | ZnO | γ-APTES | 1-2 | 39 | 0.24 | A | A | C | C |
| Comparative Example 6 | ZnO | γ-APTES | 1-2 | 41 | 0.27 | A | A | B | C |
| Comparative Example 9 | ZnO | γ-APTES | 1-2 | 43 | 0.24 | C | C | C | C |
| Comparative Example 10 | ZnO | γ-APTES | 1-2 | 4 | 0.26 | A | A | B | C |
| Comparative Example 11 | ZnO | γ-APTES | 1-2 | 3 | 0.24 | C | C | C | C |
| Comparative Example 12 | ZnO | γ-APTES | 1-2 | 4 | 0.89 | A | A | C | C |
| Comparative Example 13 | ZnO | γ-APTES | 1-2 | 42 | 0.93 | A | A | C | C |
| Comparative Example 14 | ZnO | None | 1-2 | 1.8 | 0.30 | C | C | A | C |

It can be seen from the above-described results that, when the Examples are compared to the Comparative Examples, an increase between the initial-stage residual potential and the residual potential after printing 300,000 images is suppressed in Examples.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic photoreceptor comprising:
a conductive substrate;
an undercoat layer that is provided on the conductive layer and includes a binder resin, metal oxide particles, and an electron-accepting compound having an acidic group; and
a photosensitive layer that is provided on the undercoat layer,
wherein when the undercoat layer has a thickness of 20 μm, a transmittance T1 of the undercoat layer to light having a wavelength of 1000 nm, a transmittance T2 of the undercoat layer to light having a wavelength of 650 nm, and a transmittance T3 of the undercoat layer to light having a maximum absorption peak wavelength of the electron-accepting compound in a wavelength range from 300 nm to 1000 nm satisfy the following expressions (1) and (2):
5≦T1/T2≦40 Expression (1):
0.25≦−log₁₀(T3) Expression (2):.

2. The electrophotographic photoreceptor according to claim 1,
wherein the T1/T2 satisfies the following expression (1-1):
8≦T1/T2≦38 Expression (1-1):.

3. The electrophotographic photoreceptor according to claim 1,
wherein the T1/T2 satisfies the following expression (1-2):
10≦T1/T2≦35 Expression (1-2):.

4. The electrophotographic photoreceptor according to claim 1,
wherein the −logₙ(T3) satisfies the following expression (2-1):
0.3≦−log₁₀(T3)≦3 Expression (2-1):.

5. The electrophotographic photoreceptor according to claim 1,
wherein the −log₁₀(T3) satisfies the following expression (2-2):
0.35≦−log₁₀(T3)≦2.7 Expression (2-2):.

6. The electrophotographic photoreceptor according to claim 1,
wherein the electron-accepting compound is an anthraquinone derivative.

7. The electrophotographic photoreceptor according to claim 1,
wherein the acidic group is at least one selected from the group consisting of a hydroxyl group, a carboxyl group, and a sulfonyl group.

8. The electrophotographic photoreceptor according to claim 6,
wherein the anthraquinone derivative is a compound represented by the following formula (1): 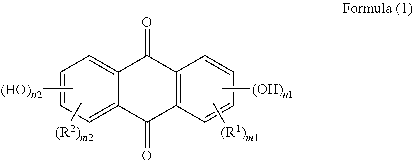
wherein in the formula (1), n1 and n2 each independently represent an integer of from 0 to 3, provided that at least one of n1 and n2 represents an integer of from 1 to 3; m1 and m2 each independently represent an integer of 0 or 1; and R¹ and R² each independently represent an alkyl group having from 1 to 10 carbon atoms or an alkoxy group having from 1 to 10 carbon atoms.

9. The electrophotographic photoreceptor according to claim 8,
wherein the R¹ and R² represent an alkoxy group having from 1 to 6 carbon atoms.

10. The electrophotographic photoreceptor according to claim 8,
wherein the R¹ and R² represent at least one group selected from the group consisting of a methoxy group, an ethoxy group, a propoxy group, and an isopropoxy group.

11. A process cartridge, which is detachable from an image forming apparatus, comprising:
the electrophotographic photoreceptor according to claim 1.

12. The process cartridge according to claim 11, further comprising:
a contact charging type charging unit that charges a surface of the electrophotographic photoreceptor.

13. An image forming apparatus comprising:
the electrophotographic photoreceptor according to claim 1;
a charging unit that charges a surface of the electrophotographic photoreceptor;
an electrostatic latent image forming unit that forms an electrostatic latent image on a charged surface of the electrophotographic photoreceptor;
a developing unit that develops the electrostatic latent image, which is formed on the surface of the electrophotographic photoreceptor, using toner to form a toner image; and
a transfer unit that transfers the toner image, which is formed on the surface of the electrophotographic photoreceptor, onto a recording medium.

14. The image forming apparatus according to claim 13,
wherein the charging unit is a contact charging type charging unit.
